(19) United States
(12) Patent Application Publication
(10) Pub. No.: US 2022/0019594 A1
(43) Pub. Date: Jan. 20, 2022

(54) DATA PROCESSING DEVICE, DATA PROCESSING PROGRAM AND DATA PROCESSING METHOD

(71) Applicant: HITACHI, LTD., Tokyo (JP)

(72) Inventors: Norifumi NISHIKAWA, Tokyo (JP); Kazuhiko MOGI, Tokyo (JP); Mika TAKATA, Tokyo (JP)

(73) Assignee: HITACHI, LTD., Tokyo (JP)

(21) Appl. No.: 17/206,447

(22) Filed: Mar. 19, 2021

(30) Foreign Application Priority Data
Jul. 15, 2020 (JP) 2020-121579

(51) Int. Cl. G06F 16/2457; G06F 16/242; G06F 16/248; G06F 16/21

(52) U.S. Cl. CPC G06F 16/24578; G06F 16/217; G06F 16/248; G06F 16/2425

(57) ABSTRACT

To support an efficient data search. A data processing device comprises a processor, and additionally comprises, as processing units which run on the processor, a generation unit which generates a generated search condition, which is a new search condition, based on a designated search condition, which is a given search condition, an estimation unit which estimates, for each search condition, a number of results of a search conducted based on the designated search condition and the generated search condition by using statistical information of a database to be searched, an evaluation unit which evaluates the generated search condition, and an output unit which outputs a number of estimated results of the designated search condition, and additionally outputs the generated search condition and a number of estimated results and an evaluation result of the generated search condition.

### TECHNICAL FIELD

The present invention relates to a data processing device, a data processing program and a data processing method.

### BACKGROUND ART

Conventionally, in order to support a data search, known is the technology described in Japanese Unexamined Patent Application Publication No. 2007-316798 (PTL 1). PTL 1 provides the following description: “Use frequency information of a search condition, co-occurrence frequency information between search conditions, field-specific relationship information, search condition-based use history information, and related use history information are stored in a database, the database is referenced based on previously set search conditions, a recommendation level of other search conditions is calculated, and a search condition having a high recommendation level and likely to be simultaneously used with the previously set search conditions is placed in a prominent position.”

### CITATION LIST

### Patent Literature

[PTL 1] Japanese Unexamined Patent Application Publication No. 2007-316798

### SUMMARY OF THE INVENTION

### Problems to Be Solved By the Invention

While PTL 1 is able to present a search condition which has a high similarity and is prone to be used simultaneously, it is not possible to determine whether the search result satisfies the desired number of cases, and PTL 1 does not contribute to the reduction in the number of trials and errors. Moreover, since past case examples are used, PTL 1 is unable to exhibit its effect until a certain number of case examples are accumulated.

Thus, an object of the present invention is to reduce the number of trials and errors for obtaining the search result of the desired number of cases without depending on past case examples, and thereby support an efficient data search.

### Means to Solve the Problems

In order to achieve the foregoing purpose, with a representative example of the data processing device, the data processing program and the data processing method of the present invention, a processor generates a generated search condition, which is a new search condition, based on a designated search condition, which is a given search condition, estimates, for each search condition, a number of results of a search conducted based on the designated search condition and the generated search condition by using statistical information of a database to be searched, evaluates the generated search condition, and outputs a number of estimated results of the designated search condition, and additionally outputs the generated search condition and a number of estimated results and an evaluation result of the generated search condition.

### Advantageous Effects of the Invention

According to the present invention, it is possible to support an efficient data search. Other objects, configurations and effects will become apparent based on the following description of embodiments.

### BRIEF DESCRIPTION OF DRAWINGS

FIG. 1 is a configuration diagram of the data processing device of the first embodiment.

FIG. 2 is a specific example (part 1) of the data stored in the storage unit.

FIG. 3 is a specific example (part 2) of the data stored in the storage unit.

FIG. 4 is a flowchart showing an example of the estimation of number of searches.

FIG. 5 is a flowchart of the data processing method in the first embodiment.

FIG. 6 is a flowchart showing the processing routine of the generation of search condition.

FIG. 7 is an explanatory diagram of a specific example of the generation of search condition.

FIG. 8 is a flowchart showing the processing routine of the evaluation of search condition.

FIG. 9 is an explanatory diagram of a specific example of the evaluation of search condition.

FIG. 10 is a flowchart of the data processing method in the second embodiment.

FIG. 11 is a flowchart showing the processing routine of the calculation of distance between conditions.

FIG. 12 is a specific example of the result of the distance calculation.

FIG. 13 is a flowchart of the data processing method in the third embodiment.

FIG. 14 is an explanatory diagram of the fourth embodiment.

FIG. 15 is an explanatory diagram of the fifth embodiment.

FIG. 16 is an explanatory diagram of the sixth embodiment.

### DESCRIPTION OF EMBODIMENTS

Embodiments of the present invention are now explained with reference to the appended drawings. The embodiments described below do not limit the claimed invention, and the various elements and all combinations thereof explained in the embodiments may not necessarily be essential as the solution of this invention.

In the following explanation, an expression such as “xxx table” may be used to explain the information that is output in response to an input, but such information may be data of any type of structure. Accordingly, “xxx table” can also be referred to as “xxx information”.

Moreover, in the following explanation, the configuration of the respective tables is merely an example, and one table may be divided into two or more tables, and all or a part of two or more tables may be one table.

Moreover, in the following explanation, there are cases where processing is explained with “program” as the subject, but since a program performs predetermined processing as a result of being executed by a processor unit while using a storage unit and/or an interface unit as appropriate, the subject of processing may also be a processor unit (or a device such as a controller comprising such processor unit).

A program may be installed in a device such as a computer, or may be installed in a program distribution server or a computer-readable (for instance, temporary) recording medium. Moreover, in the following explanation, two or more programs may be realized as one program, and one program may be realized as two or more programs.

Moreover, “processor unit” is one or more processors. While a processor is typically a microprocessor such as a CPU (Central Processing Unit), it may also be a different type of processor such as a GPU (Graphics Processing Unit). Moreover, a processor may be a single core processor or a multi core processor. Moreover, a processor may also be a processor, in the broad sense of the term, such as a hardware circuit (for instance, ab FPGA (Field-Programmable Gate Array) or an ASIC (Application Specific Integrated Circuit)) which performs a part or all of the processing.

Moreover, in the following explanation, while an identification number is used as identifying information of various targets, identifying information other than an identification number (for instance, identifier including alphabetical characters or symbols) may also be used.

Moreover, in the following explanation, when the same type of elements are explained without differentiation, a common mark within the reference mark will be used, and when the same type of elements are to be differentiated, the reference mark may be used.

### First Embodiment

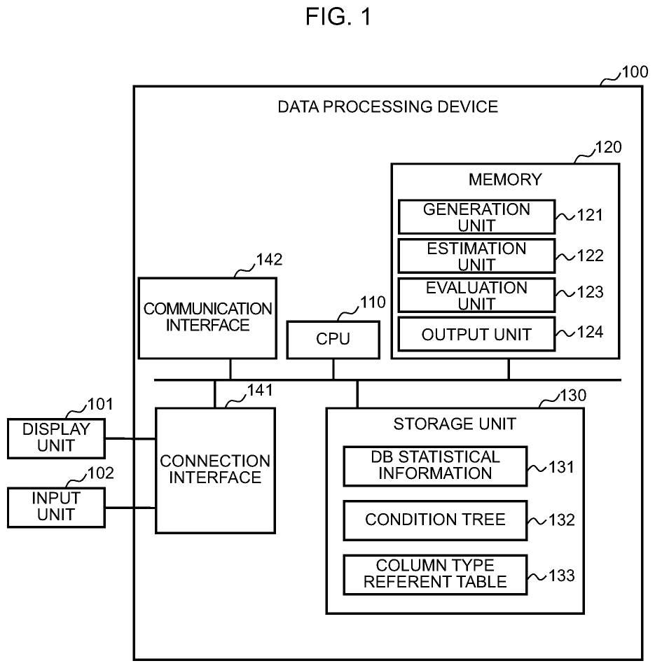

FIG. 1 is a configuration diagram of the data processing device of the first embodiment. The data processing device 100 shown in FIG. 1 is a device which performs data processing for supporting a database search, and includes a CPU 110, a memory 120, a storage unit 130, a connection interface 141, and a communication interface 142.

The data processing device 100 is connected to a display unit 101 and an input unit 102 via a connection interface 141. The display unit 101 is a liquid crystal panel or the like, and the input unit 102 is a keyboard or the like. The communication interface 142 connects a terminal operated by an operator, a database and the like via a network. In other words, the operator may use the display unit 101 and the input unit 102, or use a remote terminal. Moreover, the database storing data to be searched may exist outside the data processing device 100. While this embodiment will mainly explain the support of a data search and the explanation of the configuration and operation related to the data search itself will be omitted, the configuration related to the data search itself may be equipped in the data processing device 100, or a configuration existing externally may be used.

The storage unit 130 is an auxiliary storage device retaining information related to the support of a data search, and is configured, for example, from a hard disk, a flash drive or the like. The storage unit 130 stores database (DB) statistical information 131, a condition tree 132, and a column type referent table 133. These will be explained in detail later.

The CPU 110 realizes the functions as a generation unit 121, an estimation unit 122, an evaluation unit 123 and an output unit 124 by reading a data processing program into the memory 120 and executing the process included in the program.

The generation unit 121 generates a new search condition based on a search condition given from the operator. When differentiating the search condition given by the operator and the search condition generated by the generation unit 121, the former is hereinafter referred to as a “designated search condition”, and the latter is hereinafter referred to as a “generated search condition”.

The estimation unit 122 uses the DB statistical information 131 and estimates a number of results of the search to be conducted based on the search condition. Estimation of the number of results can be performed in the same manner for both the designated search condition and the generated search condition. The number of cases of the search result estimated by the estimation unit 122 is hereinafter referred to as the “number of estimated results”. As one example, the estimation unit 122 obtains a ratio of data corresponding to the search condition in a plurality of pieces of statistical information, and obtains a number of estimated results from a product of the ratio in each piece of statistical information.

The evaluation unit 123 evaluates the generated search condition. As one example, the evaluation unit 123 receives a designation of a priority item, which is an item to be given priority among a plurality of items included in the designated search condition, and obtains a priority ranking of a plurality of generated search conditions based on a matching degree of values of priority items of the designated search condition and the generated search condition. Here, desirably, the evaluation unit 123 determines the priority ranking of the generated search condition which satisfies a designated condition of number of results based on a matching degree of the values of the priority items, and assigns a priority ranking to the generated search condition which does not satisfy the condition of number of results that is lower than the priority ranking of the generated search condition which satisfies the condition of number of results.

The output unit 124 outputs a number of estimated results of the designated search condition, and additionally outputs the generated search condition and a number of estimated results and an evaluation result of the generated search condition. Thus, the operator can know what kind of search condition is effective for obtaining the search result of the desired number of cases.

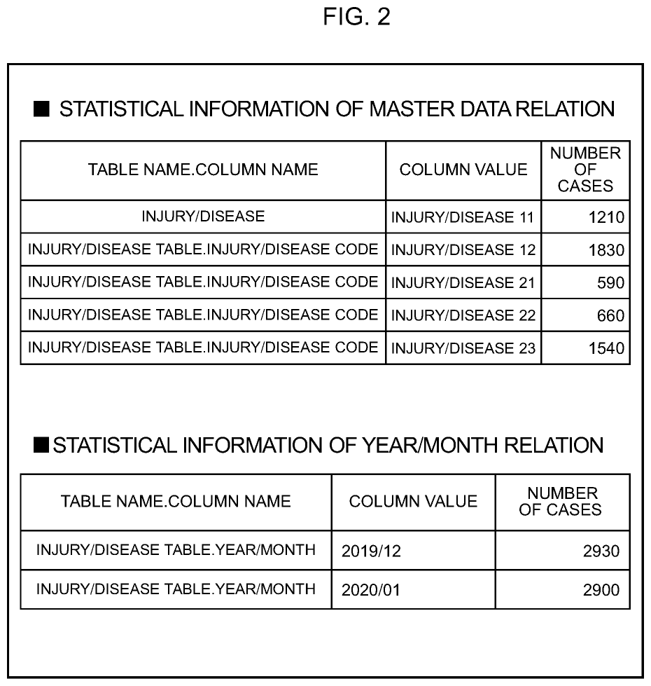

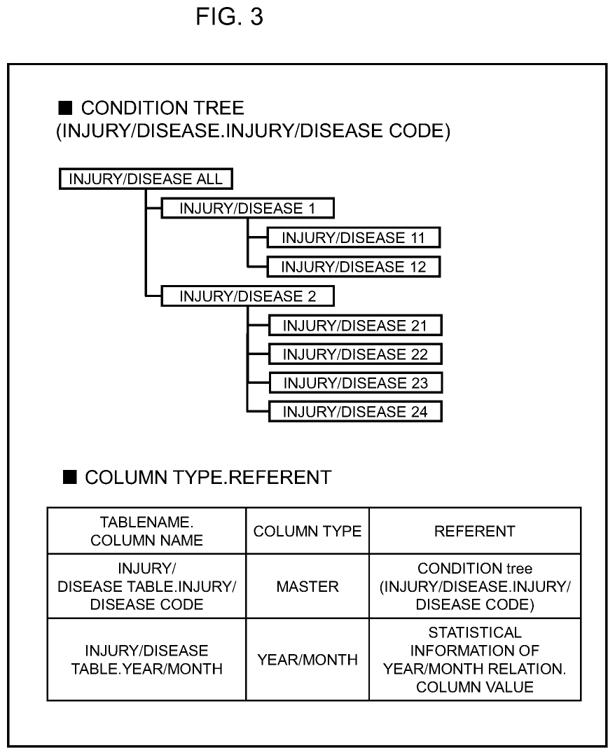

FIG. 2 and FIG. 3 are diagrams showing a specific example of the data stored in the storage unit 130. The DB statistical information 131 includes, as shown in FIG. 2, statistical information of a master data relation, and statistical information of a year/month relation. The foregoing pieces of statistical information include “table name.column name”, “column value” and “number of cases”. “Table name.column name” corresponds to the term “item” in the claims, and “column value” corresponds to the value of the item. And “number of cases” shows the number of data corresponding to that column value registered in the database.

The condition tree 132 illustrates, as shown in FIG. 3, a hierarchical structure of master data. The column type referent table 133 includes, as shown in FIG. 3, “table name.column name”, “column type” and “referent”. Based on this table, “column type” and “referent” can be identified from “table name.column name” designated in the search condition.

For example, when “table name.column name” is “injury/disease table.injury/disease code”, “column type” is “master”, and “referent” is “condition tree (injury/disease.injury/disease code)”. Similarly, when “table name.column name” is “injury/disease table.year/month”, “column type” is “year/month”, and “referent” is “statistical information of year/month relation.column value”.

In this embodiment, (a) estimation of number of results, (b) evaluation of search condition, and (c) generation of search condition are important processing. Among the foregoing processing, a specific example of the estimation of number of results is foremost explained.

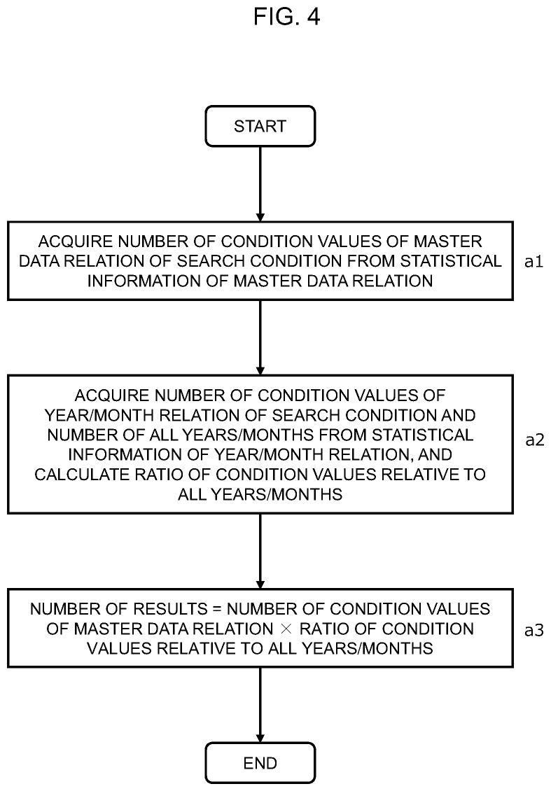

FIG. 4 is a flowchart showing an example of the estimation of number of searches. In FIG. 4, the estimation unit 122 estimates the search result by executing the steps of a1 to a3 below.

(a1) The estimation unit 122 acquires the number of condition values of the master data relation of the search condition from the statistical information of the master data relation.

(a2) The estimation unit 122 acquires the number of condition values of the year/month relation of the search condition and the number of all years/months from the statistical information of the year/month relation, and calculates the ratio of the condition values to all years/months.

(a3) The estimation unit 122 estimates the number of results based on: number of results=number of condition values of master data relation×ratio of condition values to all years/months.

For example, when the search condition is “injury/disease.injury/disease code=injury/disease 21, injury/disease 22” and “injury/disease.year/month=2019/12”:

(a1) Since the injury/disease 21 and the injury/disease 22 are designated as the injury/disease.injury/disease code, 590 cases are acquired as the number of cases of the injury/disease 21, and 660 cases are acquired as the number of cases of the injury/disease 22.

(a2) The ratio of all years/months to the condition value is calculated. As a result, it is possible to estimate that the number of condition values of the year/month relation is 2930 cases, the number of all years/months is 2930+2900=5830 cases, and the ratio of all years/months to the condition values is=2930+5830=approximately 0.5; and

(a3) number of results=(590+660)×0.5=625 cases.

To put it differently, it could be said that, in this estimation, a plurality of pieces of statistical information generated based on a plurality of different indexes from the same data group is used to obtain a ratio of each piece of statistical information to the condition values, and the value obtained by multiplying the product thereof by the total number of data is deemed the number of estimated results. In other words, the number of results is easily estimated by deeming that the distribution of values in each piece of statistical information is uniform.

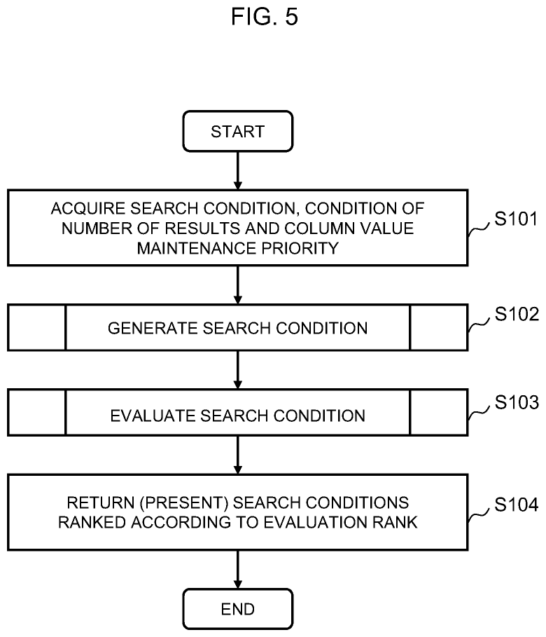

FIG. 5 is a flowchart of the data processing method in the first embodiment. With the data processing method of FIG. 5, foremost, the data processing device 100 acquires a search condition, a condition of number of results and a column value maintenance priority (step S101). Here, the received search condition becomes the designated search condition. The column value maintenance priority is a designation of a priority item, which is an item to be given priority among a plurality of items included in the designated search condition. In other words, the column value maintenance priority designates which column value should be preferentially maintained.

By using the foregoing information, the generation unit 121 generates a search condition (step S102), and the evaluation unit 123 evaluates the search condition (step S103). Thereafter, the output unit 124 presents, by returning, the search condition ranked according to the evaluation rank (step S104), and then ends the processing.

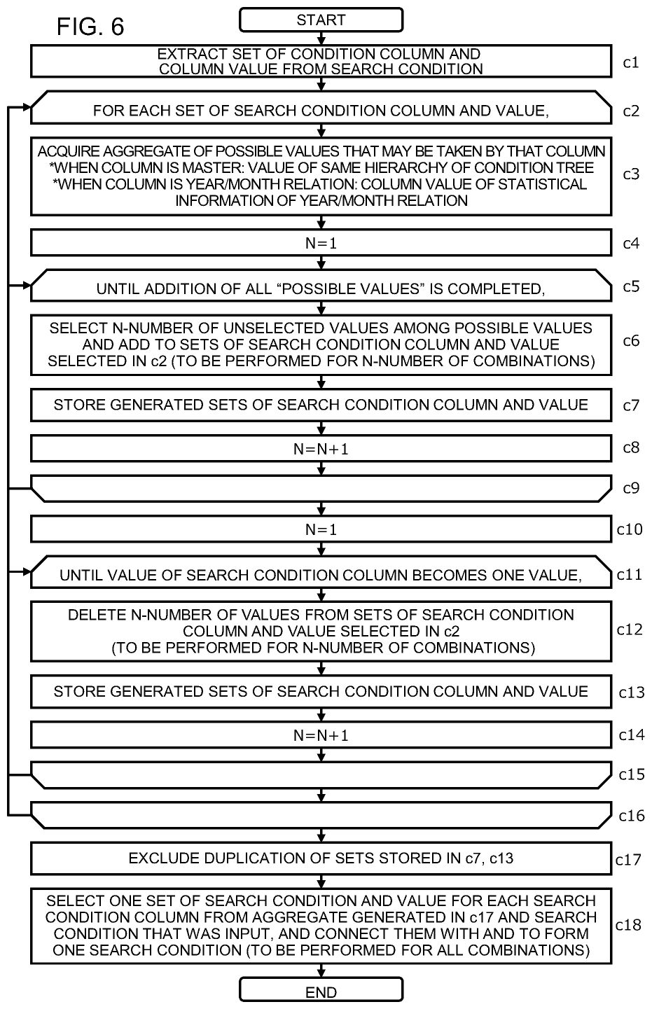

FIG. 6 is a flowchart showing the processing routine of the generation of search condition. This processing routine can be used as step S102 of FIG. 5. When the processing is started, the generation unit 121 estimates the search condition by executing the steps of following c1 to c18.

(c1) The generation unit 121 extracts a set of the condition column and the column value from the search condition.

(c2) The generation unit 121 repeats c3 to c15 for each set of the search condition column and value.

(c3) The generation unit 121 acquires an aggregate of possible values that may be taken by that column. Here, when the column is a master, the value of the same hierarchy of the condition tree is the target, and when the column is a year/month relation, the column value of the statistical information of the year/month relation is the target.

(c4) The generation unit 121 deems N=1.

(c5) The generation unit 121 repeats c6 to c8 until the addition of all “possible values” is completed.

(c6) The generation unit 121 selects N-number of unselected values among the possible values and adds them to the sets of the search condition column and value selected in c2 (to be performed for N-number of combinations).

(c7) The generation unit 121 stores the generated sets of the search condition column and value.

(c8) The generation unit 121 increments N.

(c9) The generation unit 121 determines whether the loop from c5 has been terminated, and proceeds to c10 when the loop has been terminated.

(c10) The generation unit 121 deems N=1.

(c11) The generation unit 121 repeats the processing of c12 to c14 until the value of the search condition column becomes one value.

(c12) The generation unit 121 deletes N-number of values from the sets of the search condition column and value selected in c2 (to be performed for N-number of combinations).

(c13) The generation unit 121 stores the generated sets of the search condition column and value.

(c14) The generation unit 121 increments N.

(c15) The generation unit 121 determines whether the loop from c11 has been terminated, and proceeds to c16 when the loop has been terminated.

(c16) The generation unit 121 determines whether the loop from c2 has been terminated, and proceeds to c17 when the loop has been terminated.

(c17) The generation unit 121 excludes the duplication of the sets stored in c7 and c13.

(c18) The generation unit 121 selects one set of the search condition and value for each search condition column from the aggregate generated in c17 and the search condition that was input, and connects them with AND to form one search condition (to be performed for all combinations).

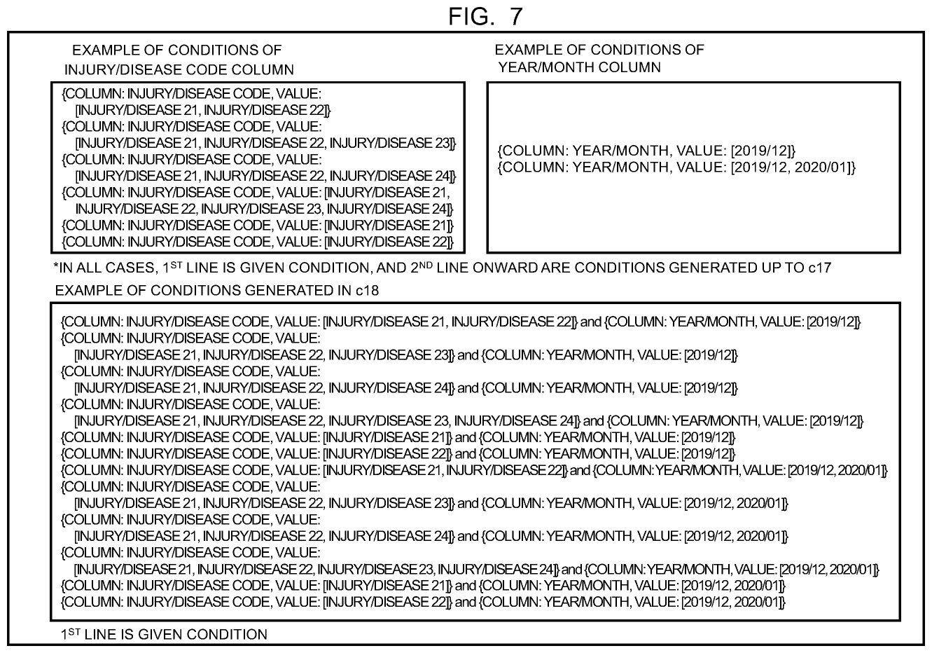

FIG. 7 is an explanatory diagram of a specific example of the generation of search condition. FIG. 7 shows a case where, as the search condition, “injury/disease.injury/disease code=injury/disease 21, injury/disease 22” and “injury/disease.year/month=2019/12” have been given.

When the search condition is given, the generation unit 121 extracts a set of a search condition column and a column value in step c1. In the example of this search condition, the two sets of {search condition column: injury/disease.injury/disease code, column value: [injury/disease 21, injury/disease 22]} and {search condition column: injury/disease.year/month, column value: [2019/12]} are extracted (these sets are hereinafter indicated as {column: injury/disease code, value: [injury/disease 21, injury/disease 22]} and {column: year/month, value: [2019/12]}).

Next, the generation unit 121 performs the following (c3 to 15) to the acquired sets of search condition column and value (in the foregoing case, the two sets of {column: injury/disease code, value: [injury/disease 21, injury/disease 22]} and {column: year/month, value: [2019/12]}) (c2).

The generation unit 121 foremost acquires, with regard to the set in which the column is the injury/disease code, an aggregate of the possible values that may be taken by that column (c3). In this example, since it is known that the column is a master and the referent is a condition tree (injury/disease.injury/disease code) based on the column type/referent table, reference is made to the condition tree (injury/disease. injury/disease code). Since the values of this set are the injury/disease 21 and the injury/disease 22, when referring to the values of the same hierarchy as these values, it can be seen that there are the injury/diseases 21, 22, 23, and 24.

The generation unit 121 sets 1 in N (c4), and then performs the following (c6 to c8) until all values acquired in step c3 are added to the values of the set (c5).

The generation unit 121 selects N-number of unselected values among the possible values obtained in c3. In this example, since the injury/disease 23 and the injury/disease 24 are not selected, the generation unit 121 creates the set {column: injury/disease code, value: [injury/disease 21, injury/disease 22, injury/disease 23]} in which the injury/disease 23 has been selected and added and the set {column: injury/disease code, value: [injury/disease 21, injury/disease 22, injury/disease 24]} in which the injury/disease 24 has been added (c6), stores the created sets (c7), and increments N by 1 (c8).

The generation unit 121 thereafter returns to c5 and, since all possible values have not yet been added (there is no set in which the injury/disease 21 to the injury/disease 24 have all been set) and the result is N=2 in c6, selects two unselected values (injury/disease 23, injury/disease 24) and adds them to {column: injury/disease code, value: [injury/disease 21, injury/disease 22]}, thereby obtains {column: injury/disease code, value: [injury/disease 21, injury/disease 22, injury/disease 23, injury/disease 24]}, and stores this in c7.

The generation unit 121 adds 1 to N in c8 and returns to c5, and then proceeds to c10 since the addition of all possible values is complete.

The generation unit 121 sets N=1 in c9, and then repeats the following (c12 to c14) until the value of the search condition column becomes one value (c11).

The generation unit 121, in c12, deletes N=1-number of values from the set of the search condition column and value selected in c2. In this example, since one value is deleted from {column: injury/disease code, value: [injury/disease 21, injury/disease 22]}, {column: injury/disease code, value: [injury/disease 21]} and {column: injury/disease code, value: [injury/disease 22]} are generated, and these are stored in c13.

The generation unit 121 thereafter increments N by 1 and returns to c11, and then proceeds to c16 since the value of the search condition column is 1.

The generation unit 121 returns to c2 from c16, and then repeats c3 to c15 regarding {column: year/month, value: [2019/12]}.

The generation unit 121 foremost obtains an aggregate of the possible values that may be taken by the year/month column in c3, but since the column is the year/month relation column in the foregoing case, the generation unit 121 refers to the column values of the statistical information table of the year/month relation and obtains 2019/12 and 2020/01, and stores {column: year/month, value: [2019/12, 2020/01]} in steps c4 to c9. Next, while the generation unit 121 performs steps c10 to c15, since there is only one value of {column: year/month, value: [2019/12]}, a new set is not obtained.

The generation unit 121 proceeds to c17 since it has proceeded to c16 and c2 and completed the processing of each set.

Foremost, since {column: injury/disease code, value: [injury/disease 21, injury/disease 22, injury/disease 23]}, {column: injury/disease code, value: [injury/disease 21, injury/disease 22, injury/disease 24]}, and {column: injury/disease code, value: [injury/disease 21, injury/disease 22, injury/disease 23, injury/disease 24]} have been newly acquired as the condition in cases where the column is the injury/disease code in c7, the generation unit 121 excludes the duplication (there is no duplication in this example) (c17). Next, in c13, since there is no new condition, the condition obtained in c17 will be {column: injury/disease code, value: [injury/disease 21, injury/disease 22, injury/disease 23]}, {column: injury/disease code, value: [injury/disease 21, injury/disease 22, injury/disease 24]}, {column: injury/disease code, value: [injury/disease 21, injury/disease 22, injury/disease 23, injury/disease 24]}, {column: injury/disease code, value: [injury/disease 21]} and {column: injury/disease code, value: [injury/disease 22]} regarding the injury/disease code, and {column: year/month, value: [2019/12, 2020/01]} regarding the year/month.

Finally, the generation unit 121, in c18, combines and generates the conditions for each column value from the condition generated in c17 and the conditions {column: injury/disease code, value: [injury/disease 21, injury/disease 22]} and {column: year/month, value: [2019/12]} that were input.

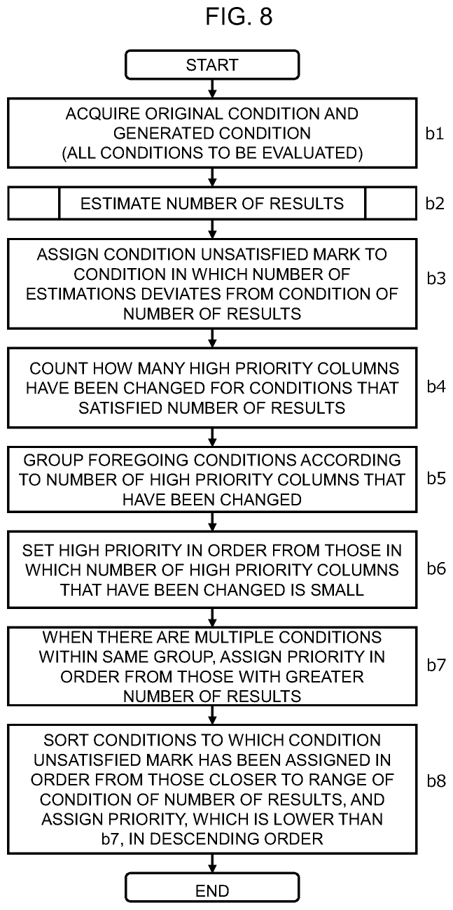

FIG. 8 is a flowchart showing the processing routine of the evaluation of search condition. This processing routine can be used as step S103 of FIG. 5. When the processing is started, the evaluation unit 123 estimates the search condition by executing the steps of following b1 to b8.

(b1) The evaluation unit 123 acquires the original condition and the generated condition (all conditions to be evaluated). An original condition is a designated search condition, and a generated condition is a generated search condition.

(b2) The estimation unit 122 estimates the number of results. This estimation may be performed with the processing shown in FIG. 4.

(b3) The evaluation unit 123 assigns a condition unsatisfied mark to a condition in which the number of estimations deviates from the condition of number of results.

(b4) The evaluation unit 123 counts how many high priority columns have been changed for conditions that satisfied the number of results.

(b5) The evaluation unit 123 groups the foregoing conditions (search conditions that satisfied the number of results) according to the number of high priority columns that have been changed.

(b6) The evaluation unit 123 sets a high priority in order from those in which the number of high priority columns that have been changed is small.

(b7) When there are multiple conditions within the same group, the evaluation unit 123 assigns a priority in order from those with a greater number of results.

(b8) The evaluation unit 123 sorts the conditions to which a condition unsatisfied mark has been assigned in order from those closer to the range of the condition of number of results, and assigns a priority, which is lower than b7, in descending order.

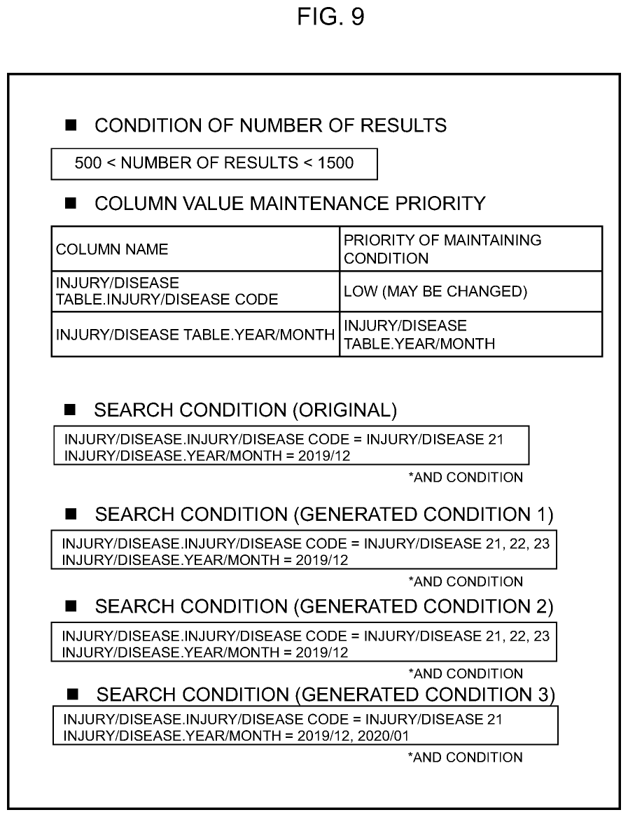

FIG. 9 is an explanatory diagram of a specific example of the evaluation of search condition. In FIG. 9, the condition of number of results is “500<number of results<1500”, and the column value maintenance priority is “injury/disease table. injury/disease code: Low (may be changed), injury/disease table.year/month: High (to be maintained as much as possible)”. Moreover, the original search condition is “injury/disease.injury/disease code=injury/disease 21, injury/disease 22” and “injury/disease.year/month=2019/12”. Moreover, three generated search conditions (generated conditions 1 to 3) have been generated from this original search condition.

In the foregoing case, foremost, the estimation of number of results of the estimation unit 122 is called in b2, and the number of estimations of generated conditions 1 to 3 is acquired. In this example, the number of estimations of the generated condition 1 is 628 cases, the number of estimations of the generated condition 2 is 1402 cases, and the number of estimations of the generated condition 3 is 590 cases. Next, in step b3, the evaluation unit 123 assigns a condition unsatisfied mark to those in which the number of estimations does not satisfy the condition of number of results, but there is no unsatisfied condition in this example (number of results: 500 to 1500).

Next, in b4, the evaluation unit 123 counts how many high priority columns of the generated conditions 1 to 3 have been changed. In this example, the result is 0 for the generated condition 1 and the generated condition 2, and the result is 1 for the generated condition 3. In b5, the evaluation unit 123 divides the conditions into a group A (generated condition 1 and generated condition 2) in which the number of changes is 0 and a group B (generated condition 3) in which the number of changes is 1. Subsequently, the evaluation unit 123 assigns a high priority to the conditions belonging to the group A (b6). Since the group A includes two conditions, in b7, the evaluation unit 123 assigns a priority in the group A in order from those with a greater number of results. In this example, a priority is assigned in the order of the generated condition 2, and then the generated condition 1. Since there is no generated condition with an unsatisfied condition, the ranking of the respective generated conditions will be, pursuant to the results described above, the generated condition 2 and the generated condition 1 belonging to the group A of a high priority, and then the generated condition 3 belonging to the group B of a low priority.

Note that, when the range of the condition of number of results is 1000 to 2000, the evaluation unit 123 assigns an unsatisfied mark to the generated condition 1 and the generated condition 3 in b3. Consequently, as the ranking, the priority of the generated condition 2 will be the highest, then the generated condition 1 in which the condition of number of results is close to the lower limit of 1000 based on b8, and then the generated condition 3.

### Second Embodiment

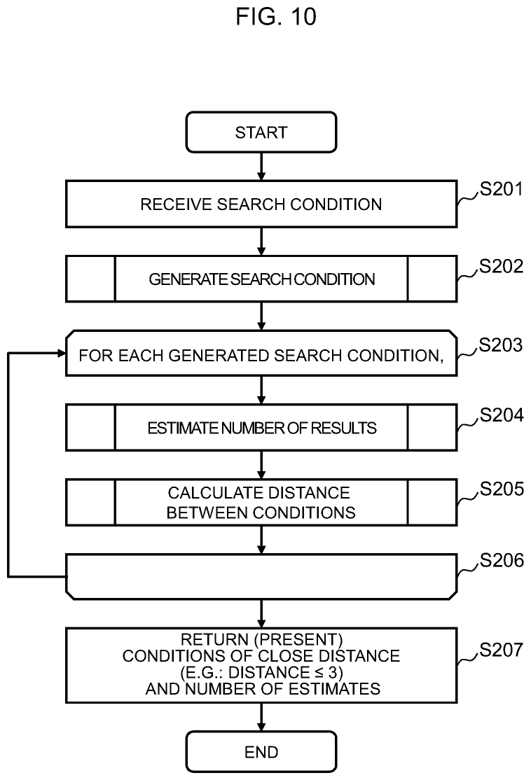

FIG. 10 is a flowchart of the data processing method in the second embodiment. The configuration of the data processing device of the second embodiment is the same as the configuration of the first embodiment. With the data processing method of FIG. 10, the data processing device 100 foremost receives a search condition (step S201). Here, the received search condition becomes the designated search condition.

The generation unit 121 uses the designated search condition and generates a search condition (step S202). Step S203 to step S206 correspond to loop processing. In this loop processing, for each search condition that is generated, estimation of the number of results by the estimation unit 122 (step S204) and calculation of the distance between conditions by the evaluation unit 123 (step S205) are repeated. After the termination of the loop, the output unit 124 presents, by returning, the conditions of a close distance (for example, distance is 3 or less) and the number of estimations (step S207), and then ends the processing.

The processing shown in FIG. 6 may be used for generating the search condition in step S202. Moreover, the processing shown in FIG. 4 may be used for estimating the number of results in step S204. In the distance calculation of step S205, the distance between the generated search condition and the designated search condition is calculated.

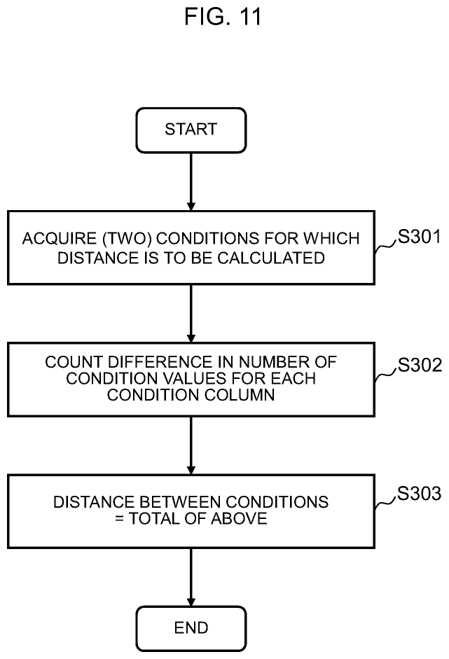

FIG. 11 is a flowchart showing the processing routine of the calculation of distance between conditions. The evaluation unit 123 foremost acquires (two) conditions for which the distance is to be measured, and counts the difference in the number of condition values for each condition column (step S302). The evaluation unit 123 subsequently totals the difference in the condition values for each condition column and uses the result as the distance between the conditions (step S303), and then ends the processing.

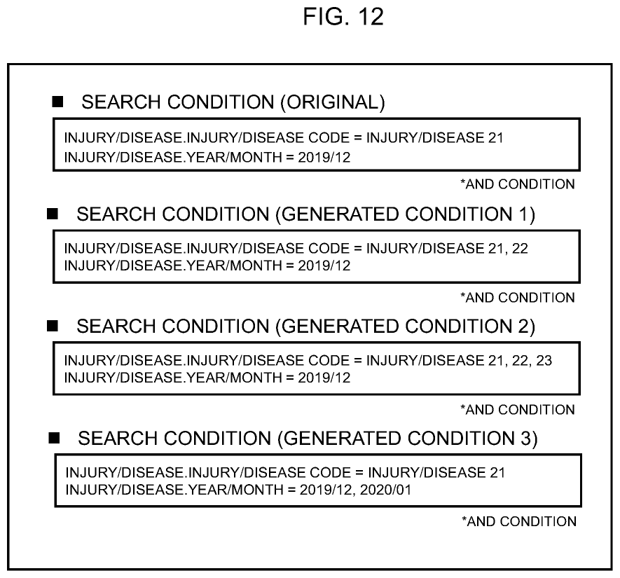

FIG. 12 is a specific example of the result of the distance calculation. In FIG. 12, when the original search condition and the generated condition 1 are compared, since one value of the injury/disease code is different, the distance will be 1. Moreover, when comparing the original search condition and the generated condition 2, since two values of the injury/disease code are different, the distance will be 2. Furthermore, when comparing the original search condition and the generated condition 3, since one value of the year/month is different, the distance will be 1.

### Third Embodiment

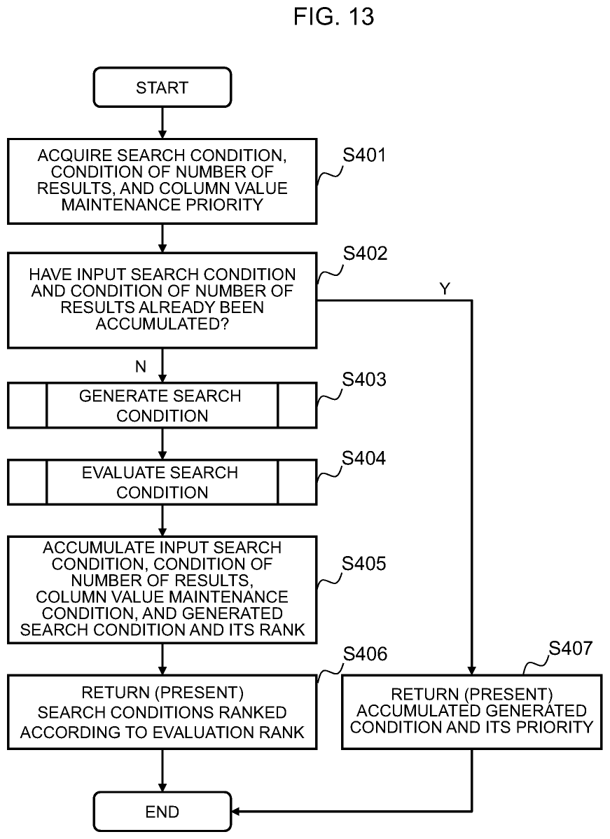

FIG. 13 is a flowchart of the data processing method in the third embodiment. The data processing device of the third embodiment comprises a configuration for accumulating and retaining a condition history in addition to the same configuration as the first embodiment. For example, by storing the condition history in the storage unit 130, the storage unit 130 will function as a condition history retention unit. Moreover, by reading a predetermined process into the memory and executing such process, the memory can function as a registration unit which registers the condition history.

Here, a condition history is an association of the generated search condition, which was generated in the past, and the number of estimated results. The data processing device 100 of the third embodiment refers to the condition history upon receiving a designated search condition, and returns such generated search condition if a generated search condition, which is the same as the designated search condition, has previously been accumulated.

Specifically, as shown in FIG. 13, the data processing device 100 foremost acquires a search condition, a condition of number of results, and a column value maintenance priority (step S401). Here, the received search condition becomes the designated search condition. The column value maintenance priority is a designation of a priority item, which is an item to be given priority among a plurality of items included in the designated search condition. In other words, the column value maintenance priority designates which column value should be preferentially maintained.

The generation unit 121 determines whether the input search condition and condition of number of results have been previously accumulated (step S402). When the input search condition and condition of number of results have been previously accumulated (step S402; Y), the output unit 124 presents, by returning, the accumulated generated condition and its priority (step S407), and then ends the processing.

When the input search condition and condition of number of results have not been previously accumulated (step S402; N), the generation unit 121 uses the input information and generates a search condition (step S403), and the evaluation unit 123 evaluates the search condition (step S404). Subsequently, the registration unit accumulates, in the condition history retention unit, the input search condition, condition of number of results, column value maintenance condition, and the generated search condition and its rank (step S405), and the output unit 124 presents, by returning, the search condition which was ranked according to the evaluation rank (step S406), and then ends the processing.

While the third embodiment explained a case of executing the operation of the first embodiment when the designated search condition has not yet been registered, the operation of the second embodiment may also be executed when the designated search condition has not yet been registered.

Moreover, while the third embodiment explained a case of registering the past generated search condition and the number of estimated results as the condition history, a past record of past searches executed to the database may also be registered.

### Fourth Embodiment

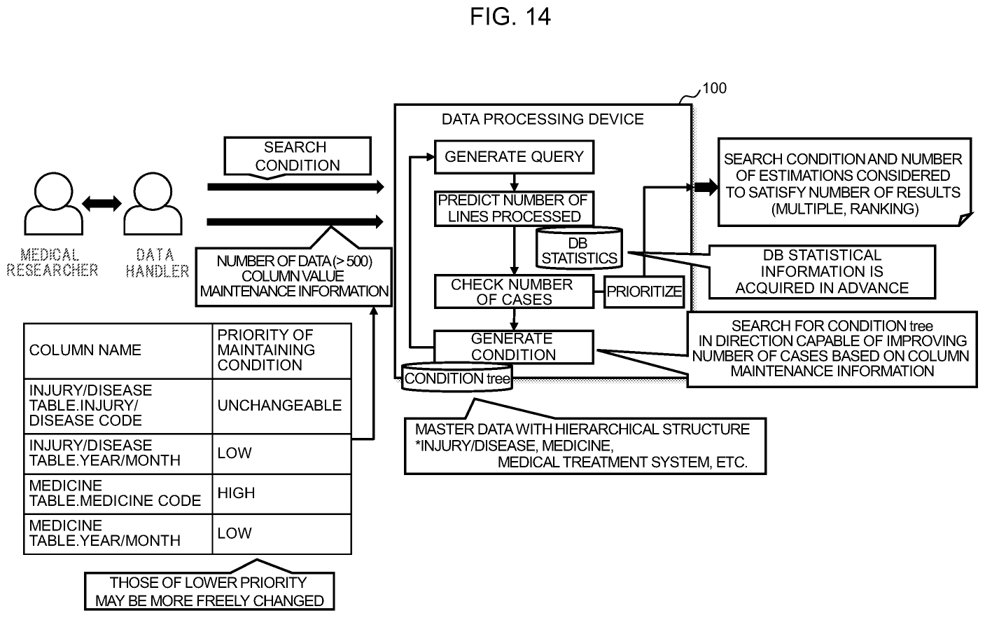

FIG. 14 is an explanatory diagram of the fourth embodiment. In the fourth embodiment, the data processing device 100 is operated by a data handler as the operator. The data handler receives a request from a medical researcher, and inputs a search condition, desired number of data (for example, 500 or more), and column value maintenance information in the data processing device 100. The data processing device 100 that received this input generates a query, and predicts the number of lines processed from the DB statistics. Here, the number of lines processed is the number of search results of the generated query, and the prediction result of the number of lines processed corresponds to the number of estimated results.

The data processing device 100 checks the number of cases for which determination on whether the number of estimated results satisfies the desired number of data is to be performed. When the number of estimated results is small, the data processing device 100 broadens the range of the column values and generates a new search condition while referring to the condition tree or the like, and returns to query generation. Moreover, when the number of estimated results is great, the data processing device 100 narrows the range of the column values and generates a new search condition while referring to the condition tree or the like, and returns to query generation.

When the number of data is satisfied in the check of the number of cases, in the same manner as the first embodiment, the data processing device 100 assigns a priority based on the column maintenance information and the number of estimated results, and outputs the search condition considered to satisfy the number of data and the number of estimated results.

Accordingly, the data processing device 100 of the fourth embodiment generates the generated search condition which satisfies the designated search condition by easing conditions and repeating processing of generating the generated search condition when a number of estimated results of the designated search condition is less than the condition of number of results, and generates the generated search condition which satisfies the designated search condition by tightening conditions and repeating processing of generating the generated search condition when a number of estimated results of the designated search condition is greater than the condition of number of results. Consequently, it is possible to output a generated search condition which satisfies the designated condition of number of results.

### Fifth Embodiment

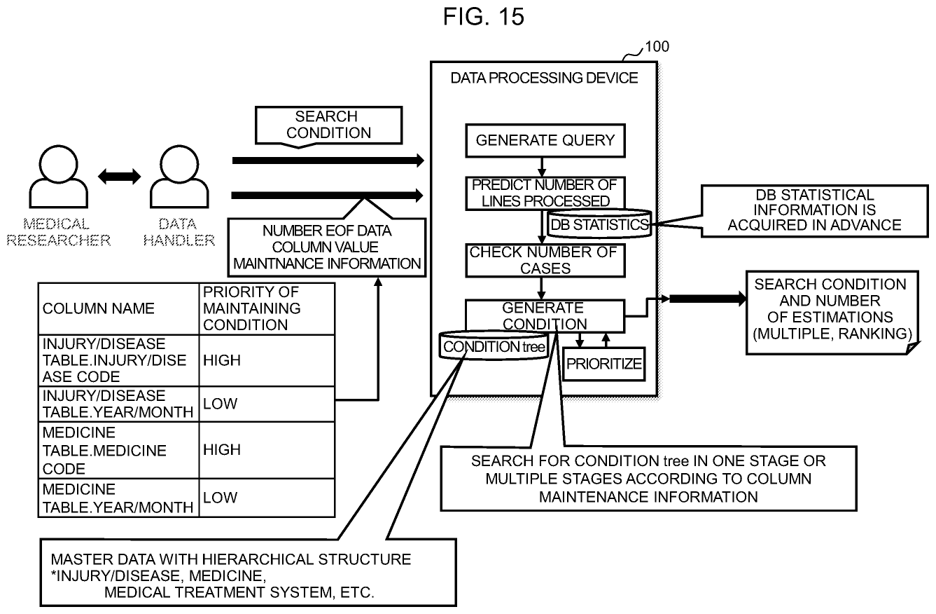

FIG. 15 is an explanatory diagram of the fifth embodiment. In the fifth embodiment, the data processing device 100 is operated by a data handler as the operator. The data handler receives a request from a medical researcher, and inputs a search condition, desired number of data, and column value maintenance information in the data processing device 100. The data processing device 100 that received this input generates a query, and predicts the number of lines processed from the DB statistics. Here, the number of lines processed is the number of search results of the generated query, and the prediction result of the number of lines processed corresponds to the number of estimated results.

The data processing device 100 checks the number of cases for which determination on whether the number of estimated results satisfies the desired number of data is to be performed. When the number of estimated results is small, the data processing device 100 broadens the range of the column values and generates a new search condition while referring to the condition tree or the like. Moreover, when the number of estimated results is great, the data processing device 100 narrows the range of the column values and generates a new search condition while referring to the condition tree or the like.

Subsequently, in the same manner as the first embodiment, the data processing device 100 assigns a priority based on the column maintenance information and the number of estimated results, and outputs the search condition considered to satisfy the number of data and the number of estimated results.

Accordingly, the data processing device 100 of the fifth embodiment generates the generated search condition which is similar to the designated search condition when a number of estimated results of the designated search condition is less than a designated condition of number of results, and outputs the number of estimated results and the evaluation result of the generated search condition. Thus, the data handler can efficiently determine the next designated search condition by referring to the output of the data processing device 100. In particular, by using the result from checking the number of cases and generating and presenting a new search condition so that the number of estimated results of the designated search condition will approach the desired number of cases, it is possible to considerably contribute to the reduction in the number of trials and errors.

### Sixth Embodiment

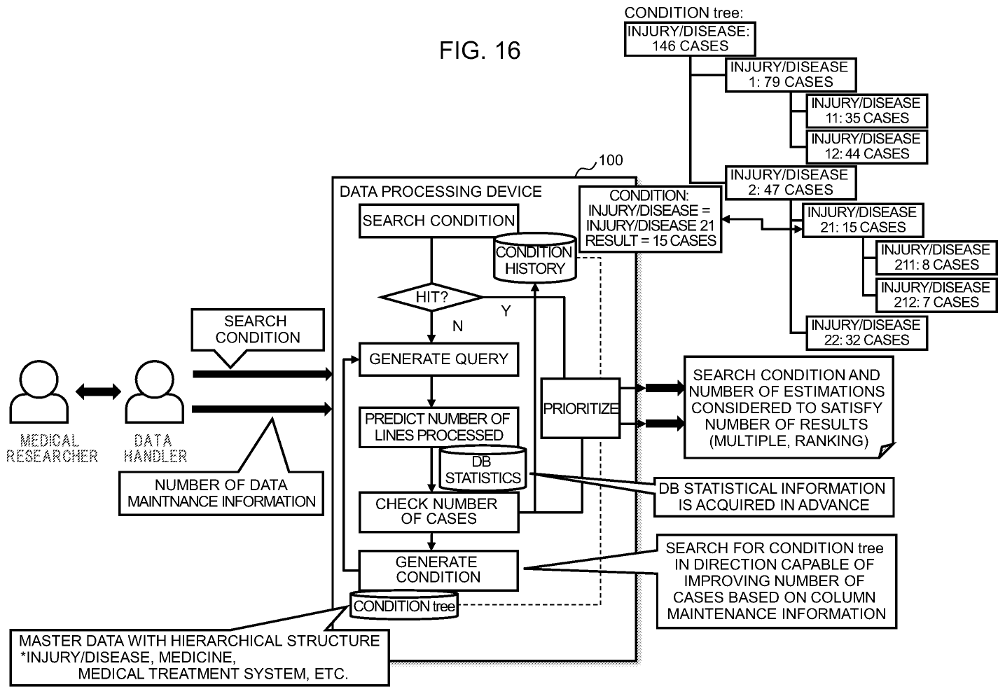

FIG. 16 is an explanatory diagram of the sixth embodiment. In the sixth embodiment, the data processing device 100 is operated by a data handler as the operator. The data handler receives a request from a medical researcher, and inputs a search condition, desired number of data, and column value maintenance information in the data processing device 100. The data processing device 100 that received this input performs a condition search and searches for a similar condition from a condition history.

When there is a condition which is similar to the condition history, the data processing device 100 presents the obtained similar condition and a number of results based on that similar condition. Specifically, the data processing device 100 presents a search condition which satisfies the number of cases in the vicinity of the condition tree. Thus, it is possible to avoid the extraction of an unrelated search condition even if it satisfies the number of cases. Moreover, when there are a plurality of search conditions, a search condition to be presented preferentially is presented based on the column maintenance information.

When there is no condition which is similar to the condition history, the data processing device 100 performs the same processing as the fourth embodiment, generates a search condition considered to satisfy the number of cases of data, and presents the generated search condition. The data processing device 100 thereafter associates the generated search condition and the number of estimated results with the condition tree, and registers this in the condition history.

While FIG. 16 shows a case of performing the same processing as the fourth embodiment when there is no condition which is similar to the condition history, the same processing as the fourth embodiment may be performed when there is no condition which is similar to the condition history.

Moreover, while FIG. 16 shows a case of registering the past generated search condition and the number of estimated results as the condition history, a past record of past searches executed to the database may also be registered.

As described above, the data processing device 100 disclosed in the foregoing embodiments comprises a processor, and additionally comprises, as processing units which run on the processor, a generation unit 121 which generates a generated search condition, which is a new search condition, based on a designated search condition, which is a given search condition, an estimation unit 122 which estimates, for each search condition, a number of results of a search conducted based on the designated search condition and the generated search condition by using statistical information of a database to be searched, an evaluation unit 123 which evaluates the generated search condition, and an output unit 124 which outputs a number of estimated results of the designated search condition, and additionally outputs the generated search condition and a number of estimated results and an evaluation result of the generated search condition.

According to the foregoing configuration and operation, it is possible to reduce the number of trials and errors for obtaining the search result of the desired number of cases without depending on past case examples, and thereby support an efficient data search.

Moreover, according to the foregoing embodiment, the evaluation unit 123 receives a designation of a priority item, which is an item to be given priority among a plurality of items included in the designated search condition, and obtains a priority ranking of a plurality of generated search conditions based on a matching degree of values of priority items of the designated search condition and the generated search condition. As one example, the evaluation unit 123 determines the priority ranking of the generated search condition which satisfies a designated condition of number of results based on a matching degree of the values of the priority items, and assigns a priority ranking to the generated search condition which does not satisfy the condition of number of results that is lower than the priority ranking of the generated search condition which satisfies the condition of number of results.

As a result of providing, together with the search condition, a priority ranking based on designated items to be given priority, it is possible to support the designation of a proper search condition.

Moreover, according to the foregoing embodiment, the evaluation unit 123, for each item included in the designated search condition, quantifies a difference between values of items of the designated search condition and the generated search condition, and sets, as an evaluated value, a total of numerical values of the difference of each item. Thus, a generated search condition which is similar to the designated search condition can be easily selected.

Moreover, according to the foregoing embodiment, the estimation unit 122 obtains a ratio of data corresponding to the search condition in a plurality of pieces of statistical information, and obtains a number of estimated results from a product of the ratio in each piece of statistical information. Thus, the research result in response to the search condition can be easily and quickly estimated.

Moreover, according to the foregoing embodiment, the output unit 124 outputs the generated search condition which satisfies a designated condition of number of results. As one example, the generation unit 121 generates the generated search condition which satisfies the designated search condition by easing conditions and repeating processing of generating the generated search condition when a number of estimated results of the designated search condition is less than the condition of number of results, and generates the generated search condition which satisfies the designated search condition by tightening conditions and repeating processing of generating the generated search condition when a number of estimated results of the designated search condition is greater than the condition of number of results. According to the foregoing configuration and operation, it is possible to provide a search condition capable of obtaining the designated number of search results.

Moreover, according to the foregoing embodiment, the generation unit 121 generates the generated search condition which is similar to the designated search condition when a number of estimated results of the designated search condition is less than a designated condition of number of results, and the output unit 124 outputs the generated search condition which is similar to the designated search condition, and a number of estimated results and an evaluation result of the generated search condition. According to the foregoing configuration and operation, the operator can refer to the generated search condition and input the next designated search condition, and thereby search for an optimal search condition interactively.

Moreover, according to the foregoing embodiment, the data processing device 100 further comprises a condition history retention unit which retains, as a condition history, a past record of a past search and/or a past record of a past number of estimated results together with a search condition, and the generation unit 121 generates the generated search condition when there is no condition which is similar to the designated search condition, and the output unit, when there is a condition history which is similar to the designated search condition, outputs the condition history. According to the foregoing configuration and operation, it is possible to effectively use past records, and generate a new search condition as needed.

Moreover, the foregoing operation of the data processing device 100 can also be performed as a data processing program, and can also be performed as a data processing method.

Note that the present invention is not limited to the foregoing embodiments, and includes various modified examples. For example, while the foregoing embodiments were explained in detail to describe the present invention in an easy-to-understand manner, the present invention is not necessarily limited to the type configuring all of the configurations explained above. Moreover, without limitation to such deletion of a configuration, a configuration may also be substituted or added.

For instance, without limitation to the illustrated database, the present invention can also be applied to a search in an arbitrary database. Moreover, the data processing device 100 may also include a function for searching a database.

### REFERENCE SIGNS LIST

100: data processing device, 110: CPU, 120: memory, 121: generation unit, 122: estimation unit, 123: evaluation unit, 124: output unit, 130: storage unit, 131: DB statistical information, 132: condition tree, 133: column type referent table

1. A data processing device, comprising:
a processor;
and, as processing units which run on the processor,
a generation unit which generates a generated search condition, which is a new search condition, based on a designated search condition, which is a given search condition;
an estimation unit which estimates, for each search condition, a number of results of a search conducted based on the designated search condition and the generated search condition by using statistical information of a database to be searched;
an evaluation unit which evaluates the generated search condition; and
an output unit which outputs a number of estimated results of the designated search condition, and additionally outputs the generated search condition and a number of estimated results and an evaluation result of the generated search condition.

2. The data processing device according to claim 1,
wherein the evaluation unit receives a designation of a priority item, which is an item to be given priority among a plurality of items included in the designated search condition, and obtains a priority ranking of a plurality of generated search conditions based on a matching degree of values of priority items of the designated search condition and the generated search condition.

3. The data processing device according to claim 2,
wherein the evaluation unit determines the priority ranking of the generated search condition which satisfies a designated condition of number of results based on a matching degree of the values of the priority items, and assigns a priority ranking to the generated search condition which does not satisfy the condition of number of results that is lower than the priority ranking of the generated search condition which satisfies the condition of number of results.

4. The data processing device according to claim 1,
wherein the evaluation unit, for each item included in the designated search condition, quantifies a difference between values of items of the designated search condition and the generated search condition, and sets, as an evaluated value, a total of numerical values of the difference of each item.

5. The data processing device according to claim 1,
wherein the estimation unit obtains a ratio of data corresponding to the search condition in a plurality of pieces of statistical information, and obtains a number of estimated results from a product of the ratio in each piece of statistical information.

6. The data processing device according to claim 1,
wherein the output unit outputs the generated search condition which satisfies a designated condition of number of results.

7. The data processing device according to claim 6,
wherein the generation unit:
generates the generated search condition which satisfies the designated search condition by easing conditions and repeating processing of generating the generated search condition when a number of estimated results of the designated search condition is less than the condition of number of results; and
generates the generated search condition which satisfies the designated search condition by tightening conditions and repeating processing of generating the generated search condition when a number of estimated results of the designated search condition is greater than the condition of number of results.

8. The data processing device according to claim 1, wherein:
the generation unit generates the generated search condition which is similar to the designated search condition when a number of estimated results of the designated search condition is less than a designated condition of number of results; and
the output unit outputs the generated search condition which is similar to the designated search condition, and a number of estimated results and an evaluation result of the generated search condition.

9. The data processing device according to claim 1, further comprising:
a condition history retention unit which retains, as a condition history, a past record of a past search and/or a past record of a past number of estimated results together with a search condition,
wherein:
the generation unit generates the generated search condition when there is no condition which is similar to the designated search condition; and
the output unit, when there is a condition history which is similar to the designated search condition, outputs the condition history.

10. A data processing program,
wherein the data processing program causes a computer to execute:
a generation process of generating a generated search condition, which is a new search condition, based on a designated search condition, which is a given search condition;
an estimation process of estimating, for each search condition, a number of results of a search conducted based on the designated search condition and the generated search condition by using statistical information of a database to be searched;
an evaluation process of evaluating the generated search condition; and
an output process of outputting a number of estimated results of the designated search condition, and additionally outputting the generated search condition and a number of estimated results and an evaluation result of the generated search condition.

11. A data processing method,
wherein a processor performs:
a generation step of generating a generated search condition, which is a new search condition, based on a designated search condition, which is a given search condition;
an estimation step of estimating, for each search condition, a number of results of a search conducted based on the designated search condition and the generated search condition by using statistical information of a database to be searched;
an evaluation step of evaluating the generated search condition; and
an output step of outputting a number of estimated results of the designated search condition, and additionally outputting the generated search condition and a number of estimated results and an evaluation result of the generated search condition.
